(19) United States
(12) Patent Application Publication
(10) Pub. No.: US 2012/0301865 A1
(43) Pub. Date: Nov. 29, 2012

(54) Book for illustrating and describing activities

(76) Inventor: Carla Yvonne Taylor, Alexandria, VA (US)

(21) Appl. No.: 13/506,930

(22) Filed: May 25, 2012

Related U.S. Application Data
(60) Provisional application No. 61/457,757, filed on May 27, 2011.

(51) Int. Cl. G09B 25/00

(52) U.S. Cl. 434/365

(57) ABSTRACT

An interactive personalized activity book for illustrating and describing activities is disclosed. The book is a children's book, the subject is a child and the user is a child's parent or caregiver. The activities are directed to attending preschool or childcare, pre-kindergarten and kindergarten. The book's objective is to help a child become more comfortable with routines and new and/or unfamiliar experience(s); and to teach a child a desired behavioral pattern within the context of routines and new and/or unfamiliar experience(s). The book contains two kinds of interior pages: preprinted author's pages and pages for which the user provides the content, including a photo of the subject or an activity related to the subject. The book includes information to guide parents or caregivers on how to discuss with the child the activity illustrated on the page. Users can remove pages for which they provide content to create a separate book.

### CROSS REFERENCE TO RELATED APPLICATIONS

This application claims priority to U.S. Provisional Patent Application No. 61/457,757 entitled Book for Illustrating and Describing Activities filed May 27, 2011.

### FIELD OF THE INVENTION

The present invention is directed to a book for illustrating and describing activities to a user of the book, more particularly, the present invention is directed to such a book for activities such as, but not limited to school-day routines.

### BACKGROUND OF THE INVENTION

People, especially children, about to encounter new situations and experiencing new situations may find the anticipation and experience very stressful. This can be particularly overwhelming for children entering what is to them a “thing called school.” If they know anything at all about school, they know that they are about to be dropped off in a classroom and that their parent or caregiver will leave and they are left to wait for unknown experiences and for an unexpected period. This is similar to an adult showing up for a new job without seeing a job description. Children, like adults, need to know what to expect in order to reduce anxiety so that they feel comfortable enough to adapt to the new situation. If the new situation is school, a child needs to feel comfortable enough to succeed. In addition; there are many such situations for a young child such as: attending a new play group (i.e., a gathering of children for the purpose of playing together); attending summer camp for the first time; welcoming a new sibling into the family; welcoming and caring for a new pet; moving (e.g., to a new home and school); visiting the doctor, dentist, zoo, library, school-trip, playground, birthday—or other party with his peers, and participation on a sports team.

In addition, there are many situations for which the interactive activity book can reinforce desired behaviors and outcomes, such as: cooperating with parents—and cooperating with a child's peers, including but not limited to siblings, classmates and playmates.

This invention is also applicable to adults as well as children of all ages, including teenagers.

Teenager's lives tend to be full of changes which create variety of new and unfamiliar circumstances and environments in which a teenage must become familiar in order to succeed. Some of these new circumstances and environments include but are not limited to: Entering high school; Learning time management skills to help with juggling an increasing volume of school-related activities, e.g. completing homework and studying for exams; Establishing a routine after school, e.g., doing homework, eating dinner, getting to bed on time; Coping with different forms of competition—academically, socially and athletically—in a constructive way; Attending proms and other social events with peers; Attending college interviews and learning appropriate conduct for college interviews; And improving social manners (e.g., table manners, making introductions, being a good host).

As previously mentioned, adults facing new and/or unfamiliar circumstances or environments, e.g.: Starting a new job; Assuming additional job responsibilities; Moving/re-locating to a new area; Attending social events with unfamiliar people; Improving or learning time management skills; Coping with different forms of competition in a constructive way, e.g., competition from peers at work; Attending job interviews and learning appropriate conduct for job interviews; Improving or learning how to “network,” e.g., developing relationships with people that can help one attain one's own professional and/or personal goals; Improving manners (e.g., table manners, making introductions, being a hospitable host); Improving business etiquette (e.g., table manners for a business lunch, appropriate and inappropriate topics of discussion in the work place and with colleagues); And running a productive meeting, e.g., at work.

### SUMMARY OF THE INVENTION

A book for illustrating and describing activities for a user of the book comprises two types of interior pages: 1) A plurality of pages, heretofore referred to as “author's pages” in which the author of the book provides the content, i.e., text and photographs; and 2) A plurality of activity pages, heretofore referred to as “template pages,” for which the user has the option to personalize the content by providing text and photographs.

Each of the “author's pages” are structured the same and contain the following elements:
a) A text label, heretofore referred to as an “activity label,” describing an activity, e.g., “Circle Time;”
b) A photograph of the activity described by the activity title, e.g., a photograph (“photo”) of children engaged in “Circle Time;” and
c) Text, e.g., “Parents' Talking Tips & Helpful Hints,” to give parents and caregivers guidance on how to discuss with the child the activity described and pictured on the page, as well as other information for parents and caregivers to help the child adjust to the activity described and pictured on the page.

In an additional aspect of the author's pages, a pair of slits is cut into each corner of a preprinted photo depicting the activity described in the activity label. Each pair of slits intersects a corner of the rectangle defined by the preprinted photo. The purpose of these slits is to provide the user with the option to personalize the page with a photograph of the subject, e.g. the child of the user, engaged in the activity described in the activity label. The user can personalize the page by inserting the four corners of the subject's photo of standard size, e.g. four inches by six inches, into the four slits cut into the corners of the preprinted photo already on the page. Since the photo printed on the page is also about the size of a standard photo, e.g. four inches by six inches, the result is that the subject's photo is placed over and largely hides the photograph printed on the page.

A benefit of using the slits mechanism to hold and retain photographs placed by the user is that they leave the graphic appearance largely unmodified for both the author-provided photo and the subject's photo.

Referring now to the second set of pages, “template pages,” or a plurality of pages for which the user has the option to provide the content, i.e., photos and text—each page is structured the same and contains the following elements:
a) a designated space for the user to write his/her own description of an activity, e.g., “Arts & Crafts;”
b) a designated space of standard photo size, e.g. four inches by six inches, for the user to insert a photograph of the subject engaged in the activity described by the user's written description, e.g., a photograph of his/her child engaged in arts & crafts.
c) a designated space for the user to write his own information and notes to give the user a personalized record of her/his ideas on how to discuss with the child the activity described and pictured on the page, and how to help his child adjust to school. These tips are the user's own version of the “Parents' Talking Tips and Helpful Hints” on the “author's pages.”

In an additional aspect of the template pages, a pair of slits is cut into each corner of the square area designated for a photo. Each pair of slits is cut at an angle to the two perpendicular lines that form each corner of the square space. As with the author's pages described previously, the purpose of these slits is to provide the user with the option to insert the four corners of a personal photograph of the subject, e.g. the child, into the slits—thereby personalizing the page with a photograph of the child that corresponds to the user's written activity label.

In a further aspect of the invention, a book cover is provided with a designated squared space, e.g. four inches by six inches, for the user to insert a photograph of the child who is the subject of the book. The photograph placed by the user on the front cover is held and retained using the same slits mechanism described previously that holds and retains the user's photos on the author's pages and template pages.

In a further aspect of the invention, an introduction is provided explaining the value of the activity book in specific relation to young children attending school.

In a further aspect, the invention includes an instruction page on how to use the book.

In still a further aspect of the invention, the book is a children's book, the person is a child and the user is a child's parent or caregiver and the activities are directed to attending preschool or child care, pre-kindergarten and kindergarten.

In another aspect of the invention, the last page of the book is a school-day diary suggesting topics the parent can discuss with the child at the end of each school day.

This invention is directed to a personalized interactive activity book arrangement and a method of:

1) Helping a subject, such as a child, become more comfortable with routines (including but not limited to daily routines) and new and/or unfamiliar experience(s); and

2) Teaching a subject, such as a child, a context of routines and new and/or unfamiliar experience(s) by placing a photograph of the subject in a situation to promote the success of the subject within the context of that situation.

Further, this invention is directed to a personalized interactive activity book and method of:

Helping a subject become more comfortable with routines (including but not limited to daily routines) and new and/or unfamiliar experience(s), e.g.: Attending school or camp; Executing bedtime routines (e.g. taking a bath, putting on pajamas, picking a story book to read, getting into bed, staying in child's own bed); Executing morning routines (e.g., getting dressed, eating breakfast, getting ready for school); Cleaning up one's toys and other possessions; Executing an after-school routine (e.g., eat a snack, do homework, play or relax); Staying with a baby sitter; Spending the night at a friend's house; Joining a sports team; Welcoming a new sibling to the family, etc., and;

Teaching a subject a desired behavioral pattern within the context of routines and new and/or unfamiliar experience(s), e.g.: Including but not limited to all of the above-mentioned experiences in previous paragraph; Manners (e.g., sharing, table manners, meeting people and making introductions, etc.); Eating nutritious foods; Safely coping with food allergies or other food concerns (what to eat and avoid); How to respond to bullying: e.g., how to avoid becoming a bully at school (or other setting), how to respond to being bullied, and how to respond when you see someone else being bullied.

This book is expressed in English as well as other languages.

In an aspect of the book arrangement, the book arrangement is a children's book, the person is a child, the user is a child's parent or caregiver, and the activities are directed to attending preschool or child care, pre-kindergarten and kindergarten.

### BRIEF DESCRIPTION OF THE DRAWINGS

FIG. 1 is a perspective view of a spiral bound book configured in accordance of the principles of the present invention showing the book partially open.

FIG. 2 is a perspective view of the book of FIG. 1 showing the front of a single interior book page.

FIG. 3 is a fragmentary view of the book of FIGS. 1 and 2.

FIG. 4 is a fragmentary view of the book having a stapled backbone.

FIG. 5 is a fragmentary view of a book in accordance with the present invention having what is referred to as a “perfect binding” by those schooled in the art of book binding.

FIG. 6 is an example of the book being bound by a loose leaf notebook binder so that the user may change the order of the book's pages to better represent the child's routine.

FIG. 7 is a sample book cover according the present iteration of the invention.

FIG. 7A is a detailed view of a photo being placed by the user in a designated empty square space at the center of the cover page depicted in FIG. 7.

FIG. 7B is a flat view of FIG. 7A illustrating one of four slits cut into the designated empty square space at the center of the cover page.

FIG. 7C is a detailed view of the photo after its four corners are placed by the user into the four slits in the designated area on the cover page.

FIG. 8 is a detailed view of an alternative embodiment of the invention in which the photo placed by the user is held and retained on the front page, or on any applicable interior activity pages, by sliding the photo into a transparent sleeve affixed to the page.

FIG. 8A depicts the photo placed by the user after it has been slid into the transparent pocket depicted in FIG. 8.

FIG. 9 is an exploded view alternative embodiment of the invention in which the user's photo is held and retained on the front page, or any applicable interior activity page, by affixing the photograph to the page with glue or another kind of adhesive.

FIG. 9A depicts the user's photo after it has been affixed to the page by glue or other kind of adhesive.

FIG. 10 is an introduction page for the book.

FIG. 11 is a page describing tips for using the book;

FIG. 12 is a sample of pages 3 and 4 and represents a multiplicity of the book's interior pages which face one another.

FIG. 12A is an example of a multiplicity of interior pages, heretofore referred to as “author's pages” that contain the following information provided by the author: 1) an activity label describing the activity or environment pictured in the photo printed on the page 2) a photo illustrating the activity label; and 3) text tips to guide parents and caregivers on how to discuss the activity or environment pictured on the page with his/her child(ren).

FIG. 12B is a detailed view of the photo printed on the “author's page.”

FIG. 12C is a detailed view of FIG. 12B and illustrates one of the eight slits cut into the four corners of the photo in FIG. 12B.

FIG. 12D is a detailed view of a photo being placed by the user over the photo in FIG. 12B already printed on the “author's page.”

FIG. 12E is a detailed view of the photo after it is placed on the page by the user.

FIG. 12F depicts the full “author's page” after the photo is placed by the user as depicted in FIGS. 12D and 12E.

FIG. 13 is an example of a multiplicity of activity pages, heretofore referred to as “template pages.”

FIG. 13A is a detailed view of a photo being placed by the user onto the “template page.”

FIG. 13B is detailed view of FIG. 13A.

FIG. 13C is detailed view of the photo after it is placed on the template page by the user.

FIG. 13D is a view of the entire template page after the photo is placed on the page by the user.

FIG. 14 is an example of how the facing “author's page” (left-side of page) and “template page” (right-side of page) should look after being personalized by the user.

FIG. 15 is a daily diary, intended to be a conversation starter to discuss school, or a record of school-related activities.

FIG. 16 is the back cover of the book.

FIG. 17 is an alternative embodiment of the book in which each “template page” is perforated or dotted along the side of the page closest to the binding so that each page may be ripped out or cut out by the user and placed in any order the user wishes, to create a distinct personalized activity book that reflects the order of the child's daily activities.

FIGS. 18 and 18A are examples of how photos appearing in the book are positioned back-to-back on a single sheet of paper so that the slits cut into the single sheet of paper appear on or near the photos on each side of the single sheet of paper.

FIGS. 19 and 19A illustrate an example of an alternative embodiment of the invention in which the individual pages of the book are made up of two separate sheets being placed back-to-back and glued together.

FIGS. 20-27 are eight examples of eight pages, pages 4-11, of the book arrangement:

FIG. 20 is an example of a page 4 (template page).

FIG. 21 is an example of a page 5 (author's page).

FIG. 22 is an example of a page 6 (template page).

FIG. 23 is an example of a page 7 (author's page).

FIG. 24 is an example of a page 8 (template page).

FIG. 25 is an example of a page 9 (author's page).

FIG. 26 is an example of a 10 (template page).

FIG. 27 is an example of a page 11 (author's page).

### DETAILED DESCRIPTION

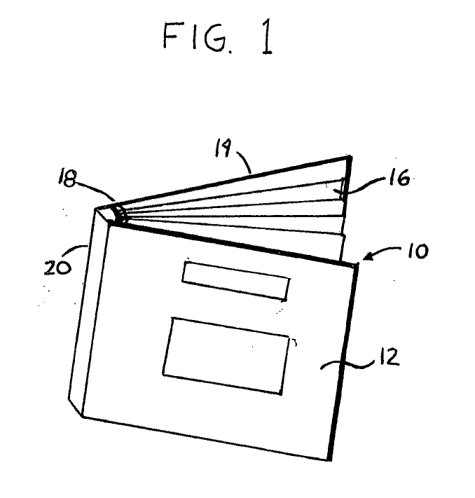

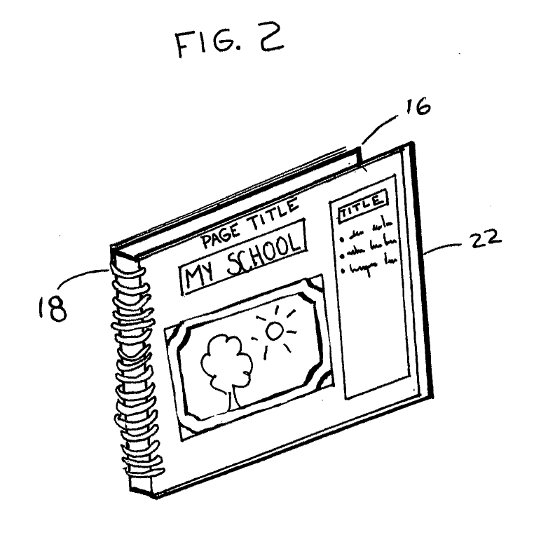

Referring now to FIGS. 1 and 2, there is a typical book 10 configured in accordance with the present invention, wherein the book 10 includes a front cover 12, a back cover 14 and a plurality of pages 16, all secured by a spiral binding, with a spine 20 for displaying the book's title, so that the pages are readily accessible for viewing while being secured between the front and back covers.

A key benefit of a spiral binding 18 of the present invention is illustrated by FIG. 2, showing that any of the book's pages 16 can be bent behind a single page 22 along the spiral binding 18 so as to only display a single page 22 at a time. This is particularly useful when a user wants to show individual pages to the child in an order that is different from the order in which the pages are bound, so that the sequence of activities portrayed better reflect the child's individual routine or schedule. Spiral binding lends itself to the personalization aspect of the activity book.

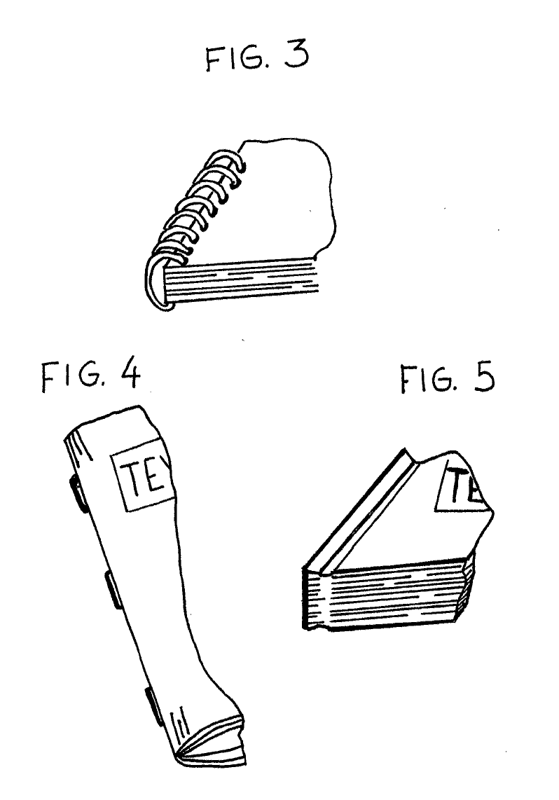

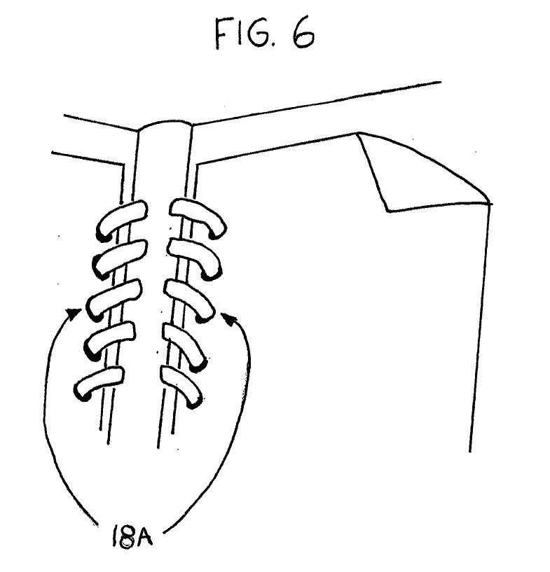

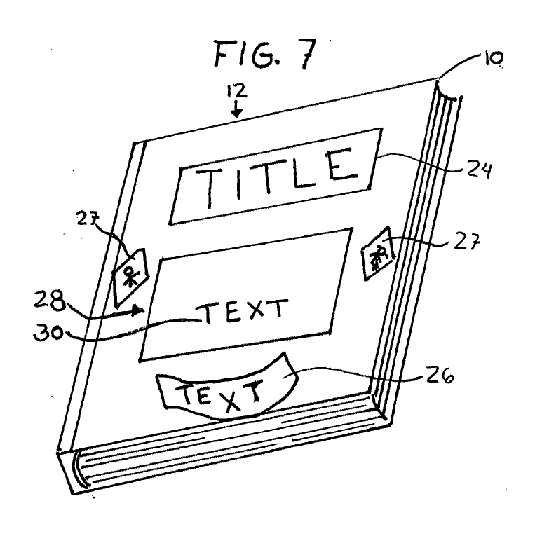

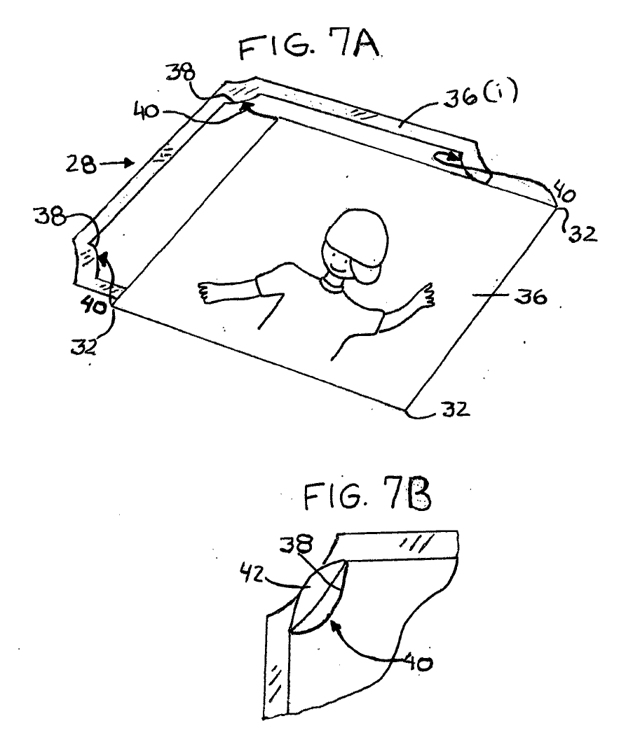

In alternative embodiments, the binding may be a spiral binding 18 with no spine for printing the book's title, as illustrated by fragmentary view FIG. 3; a stapled binding, as illustrated by fragmentary view FIG. 4; or a glued binding, or “perfect binding,” as illustrated by fragmentary view FIG. 5. In yet another alternative embodiment, the binding 18 may be replaced by a loose leaf binding arrangement 18A, as illustrated by fragmentary view FIG. 6, so that the order of pages may be changed. The loose leaf binding arrangement 18A also allows the user to show certain pages and not others in case only certain pages resemble the child's school activities or other experiences.

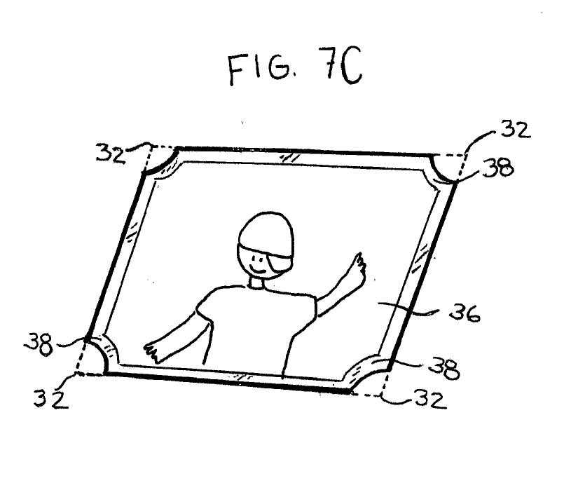

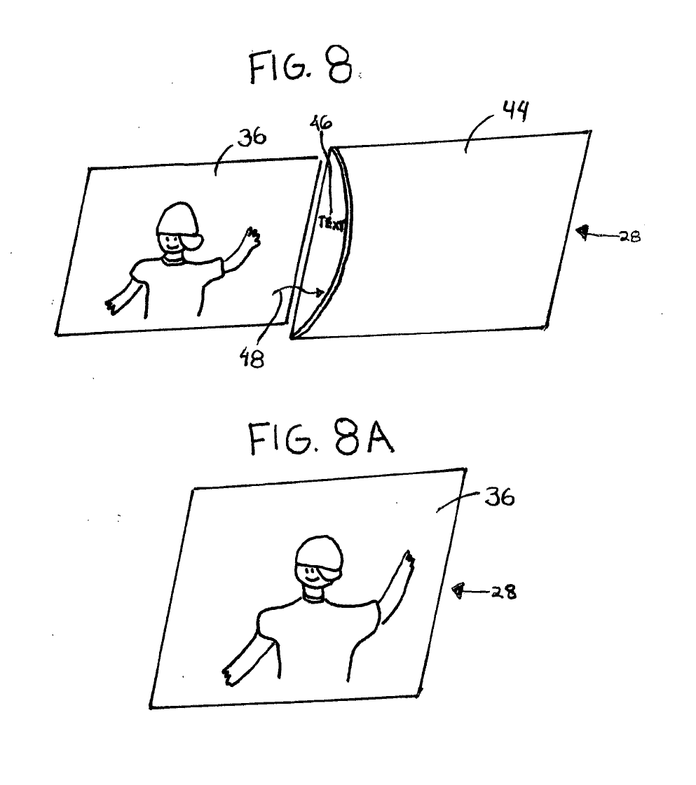

Referring now to FIG. 7, there is shown a front cover 12 of the book 10, where in the cover includes the book's title 24 and text 26 which describes the purpose of the book and describes the book as “a personalized activity book.” There also are photos 27 of children engaged in typical school activities for children ages two to five years; and a square space 28 to accommodate a user's photo of standard size, e.g. four inches by six inches. Additionally, there is text 30 inside the square space 28 instructing the user to place the child's photo there.

FIG. 7A is a detailed view of area 28 in FIG. 7, designated to receive a photo placed by the user on the book's cover page. In FIG. 7A, the user puts each corner 32 of a child's photo 36, e.g. four inches by six inches and square-shaped, into each of four curved slits 38 by placing each corner 32 of the user's photo 36 into a curved slit 38 in the direction of arrow 40.

FIG. 7B is a detailed view of FIG. 7A and shows a close-up view of the curved slit 38 and the slight opening 42 it makes in the corner of the area 28 of FIG. 7 which is designated to receive a photo placed by the user. Directional arrows 40 in FIGS. 7A and 7B indicate the directions in which the corners 32 of the user's photo 36 are placed into the curved slit 38.

FIG. 7C shows the photo 36 after it is placed by the user into the area 28 of FIG. 7.

FIGS. 8 and 8A illustrate an alternative structure for holding and retaining the photo 36 placed by the user to the designated area 28 on book's cover page. In FIG. 8 there is a transparent sleeve 44 on the book's cover page with instructions 46 to slide a child's photo 36 into the sleeve's opening as indicated by the directional arrow 48. Note that the opening of the sleeve may be on any one of four sides of the sleeve, not just the left side as illustrated in FIG. 8. Further, the sleeve's opening may include a reusable adhesive strip or flap to help secure the photo. An example of this type of sleeve is a product called “Archival Crystal Clear Art Protectors” by Print File, Inc. FIG. 8A shows the child's photo 36 as it appears after it is placed into the transparent sleeve of FIG. 8 by the user.

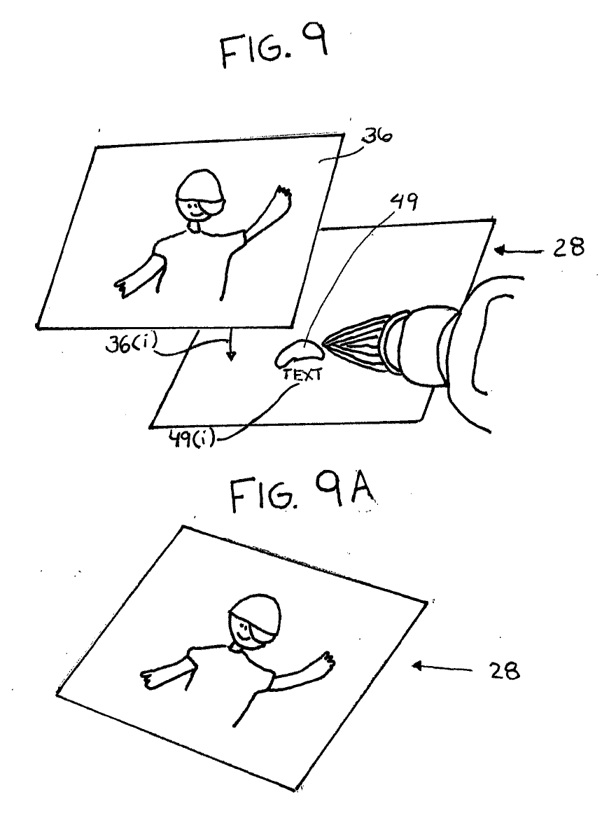

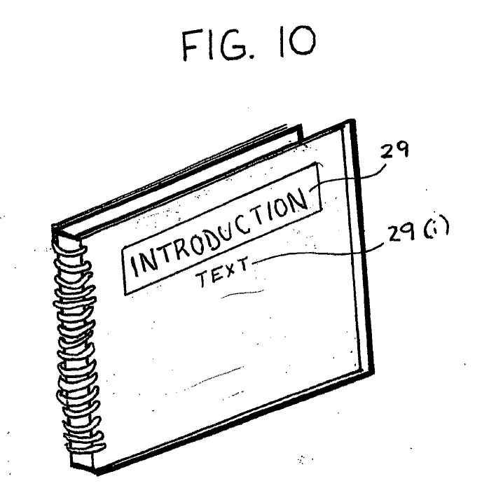

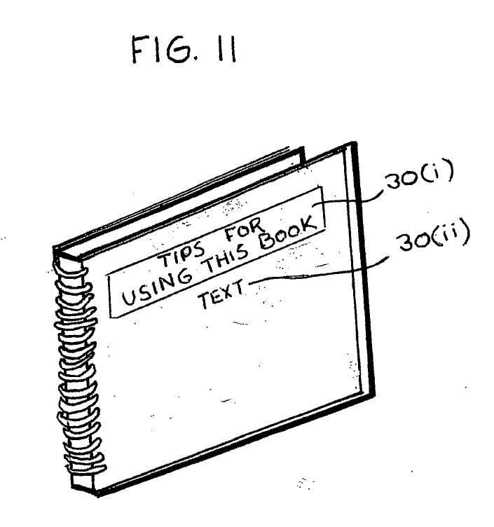

FIG. 9 illustrates yet another alternative structure for holding and retaining the photo 36 placed by the user to the designated area 28 on the book's cover page. In FIG. 9, there are instructions 49(i) to affix the child's photo 36 to the book's cover page, as indicated by directional arrow 36(i), by applying glue 49 or another adhesive. Included in this alternative embodiment is an option in which the adhesive is already applied to the page and ready to hold a photo in place.

FIG. 9A shows the user's photo 28 after it has been affixed to page. The use of stickers is another alternative mechanism for holding and retaining the user's photo to the designated area on book's cover page. For example, the book is distributed with repositionable stickers in a pocket at the back of the book. This alternative embodiment includes stickers that are designed to frame photos of standard size while they hold the photos to the page. Exemplary of the use of these kinds of stickers is Stickr™ (Frame) sold by Butch and Harold.

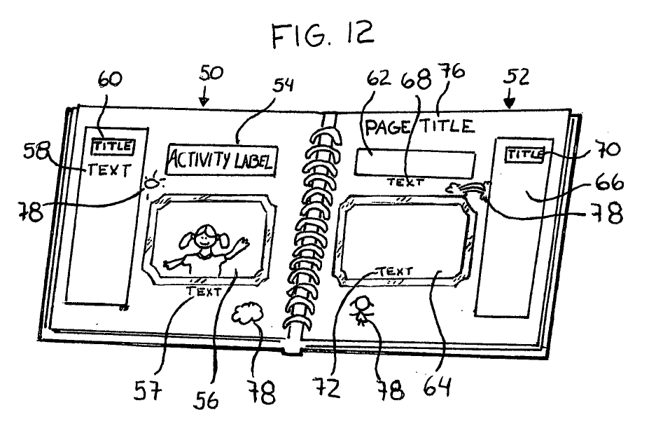

FIG. 10 is a sample first page and an introduction to using the book. In this embodiment of the invention, the introduction 29 is described as “[H]elp for stressed-out students and parents.” The text 29(i) of the introduction 29 also describes a problem, such as but not limited to, the stress of attending school for young children, parents and caregivers.

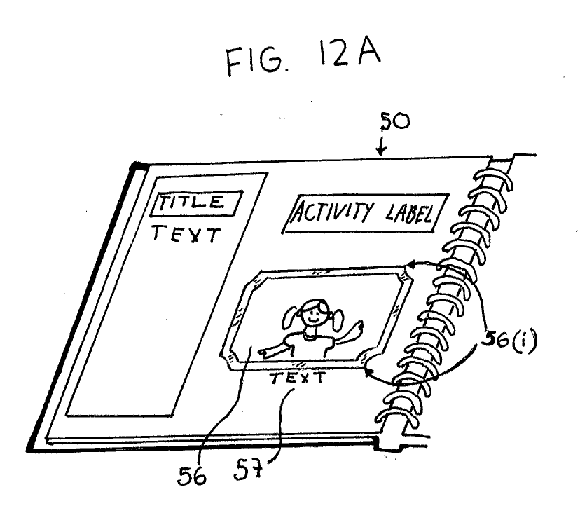

FIG. 11 is a sample second page of the book and provides instructions for using the book under the terminology “Tips for Using this Book” 30(i). The text 30(ii) of these instructions tells the user, for example, how to build his/her own personalized activity book by inserting photos on the author's pages and/or template pages, writing his/her own activity labels on the template pages, and writing his/her own parent tips on the template pages.

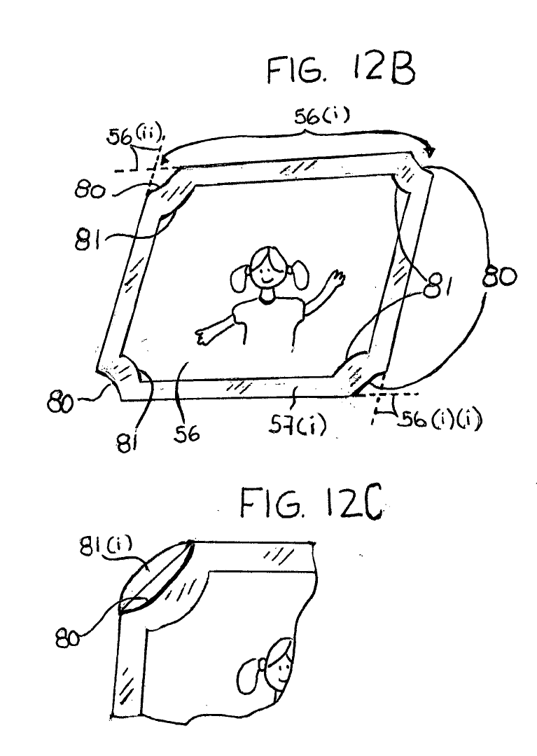

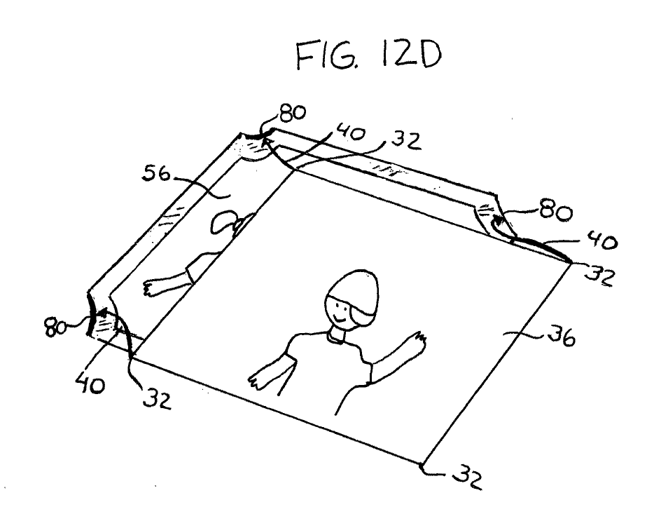

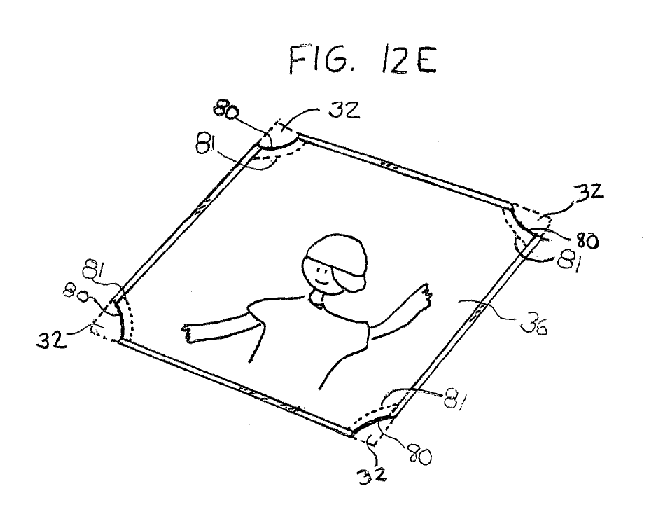

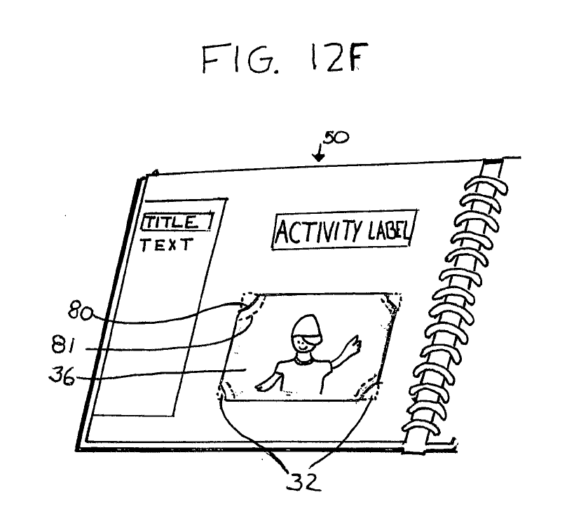

FIG. 12 illustrates the structure of a multiplicity of interior facing pages, e.g., page 3 and page 4, or page 5 and page 6. The facing pages are structured as follows: The page on the left side 50, is an “author's page” that contains content provided by the author. The page on the right side 52, is a “template page” that contains a blank template with designated spaces to be filled in with content provided by the user.

The “author's page” 50, contains an “Activity label” 54, e.g. “A classmate,” describing the activity, person or environment illustrated in the related photograph 56. The photograph 56 depicting the activity described by the text in the Activity Label 54 is e.g., a photo of a child in a school setting. The text instructions 57 tell the user how to insert his or her photo into the space provided over a photo 56 already printed on the page if he or she wishes to personalize the page by, e.g. showing a photograph of a parent's own child engaged in the activity depicted in the activity label 54.

Text tips 58 for parents provide ideas on how to discuss the activity pictured with their children. Text tips 58 also include guidance to parents on how to help their children adjust to the school routine. In this embodiment of the invention, the title 60 of these tips is, for example, “Parents' Talking Tips and Helpful Hints.”

Referring now to “template page” 52, it contains a designated space 62 for the user to write in his own, “activity label” or description of the activity pictured in the photo placed on the page by the user, as well as text instructions 68 under the activity title 62 telling the user to write in his own activity description in the space provided.

There is a designated space 64 for a photograph of typical size, e.g. four inches by six inches, to be placed by the user depicting the activity described by the text in the activity label 62. Text instructions 72 telling the user how to insert his photo into the space are provided, and a designated space 66 for the user to write his own tips to help him discuss with the child the activity pictured on the page. Numeral 70 refers to the title for the user-provided tips and information, e.g. “My Own Parents' Talking Tips & Notes;” and a page title 76 is printed at the top of the page to indicate to the user that the content of this page is to be provided by the user. In this embodiment of the invention, the page title is “My Page.” In the book's current embodiment, there also are original designs 78 on the both the “template pages” and the “author's pages.”

Both the “author's page” 50 and “template page” 52 contain similar mechanisms for holding and retaining photos placed by the user in the designated areas: the area occupied by preprinted photo 56 on the “author's page” and the blank area 64 on the “template page.”

Referring now to FIGS. 12A, 12B, 12C, 12D, 12E and 12F, there is an illustration of the mechanism for holding and retaining photos on an “author's page” 50.

In FIG. 12A, instructions 57 tell the user how to insert the photo into the designated space 56(i) over the photo 56 already printed on the page. FIG. 12B shows the pair of slits 80 and 81 cut into each corner of square space 56(i). Each pair of slits is cut at an angle to the two perpendicular lines 56(i)(i) that form each corner of the square area 56(i). Note that in an alternative embodiment, the slits 80 and 81 may be cut in a straight line instead of a curved line. Square area 56(i) is designed to hold and retain a photo that is placed by the user over the photo 56 printed on the page. FIG. 12C is a detailed view of the slight opening 81(i) in the book's page created by the slit 80 referred to in FIG. 12B. The slit illustrated in FIG. 12C, like the other slits on the “author's page,” is designed to retain and hold one of the four corners of the photo placed by the user.

FIG. 12D shows how each of the corners 32 of the user's photo 36 is placed into each of the slits 80 by following the directional arrows 40. The user's photo 36 is placed over the photo 56 printed on the page. This option is available to users who want to personalize the page by placing a photo of the user's own child, or of the child's school-related activity or environment.

FIG. 12E shows the users photo 36 being held and retained on the page by the four slits 80. The other four slits 81 are not visible because they are covered by photo 36. The four corners 32 of user's photo 36 are not visible because they are hidden under four slits 80.

FIG. 12F shows the entire “author's page” 50 with the photo 36 that has been placed by the user, i.e., the photo placed by the user is held and retained on the “author's page.” As in FIG. 12E, the four corners 32 of user's photo 36 are not visible because they are hidden under four slits 80. The other four slits 81 are not visible because they are covered by photo 36.

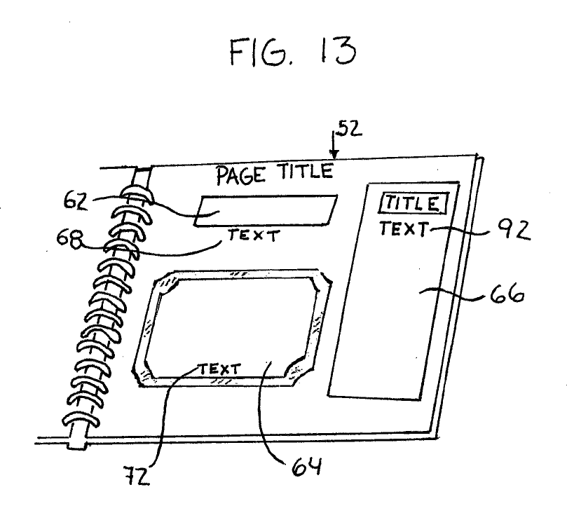

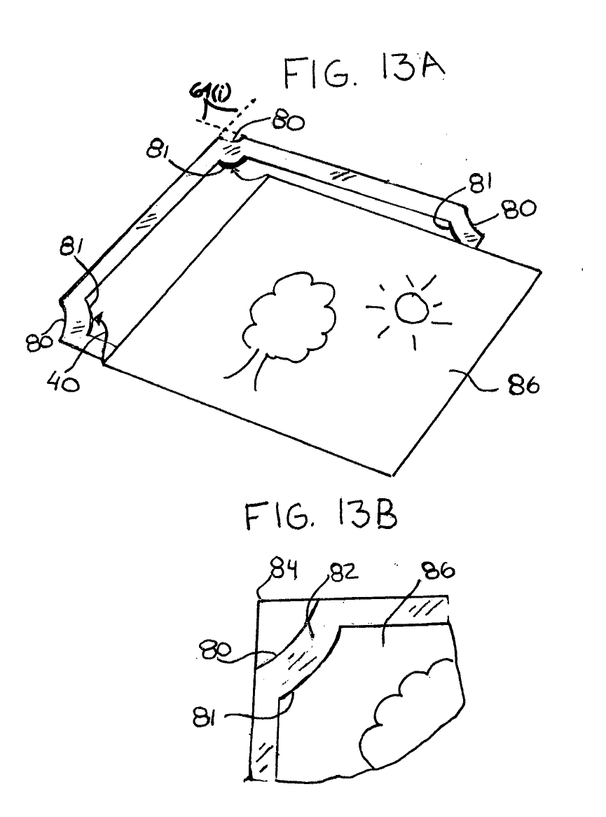

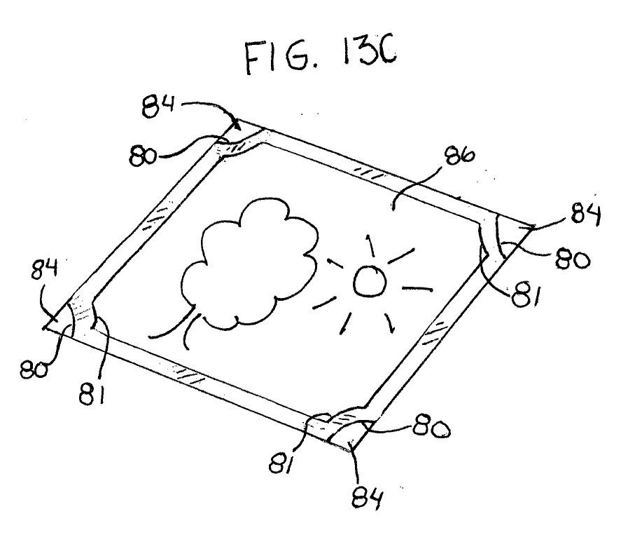

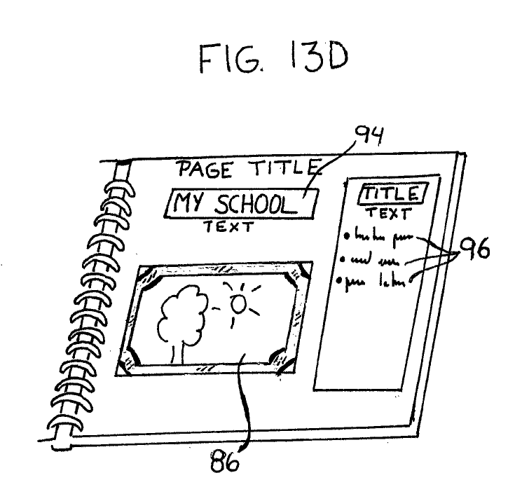

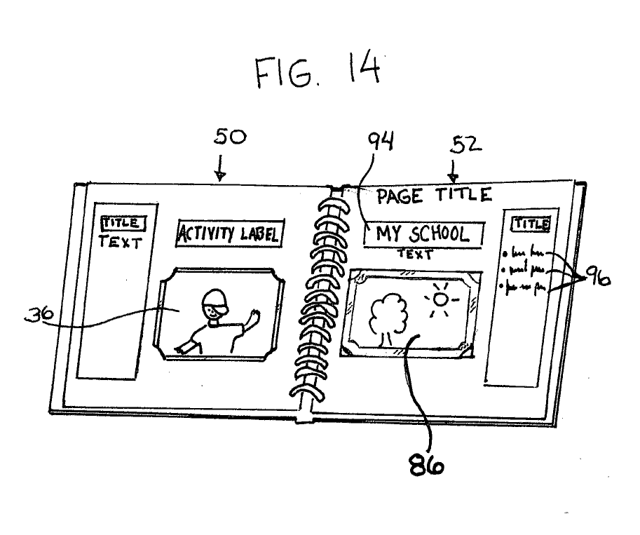

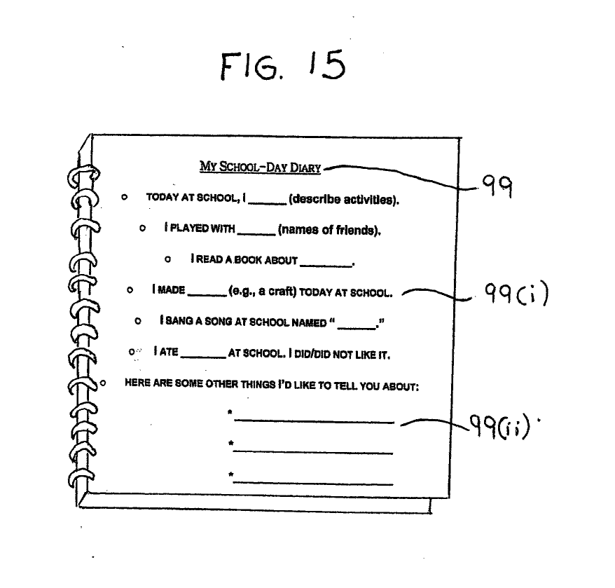

Referring to FIG. 13, each template page provides designated spaces for the user to provide his or her own, i.e. personalized, content: There is: 1) a space 62 for the user to write in his or her own activity label, which describes the activity the child (subject) is engaged in on the photo of the child (subject) placed on the page by the user; 2) a space 64 to hold and retain a photo of the child (subject) placed by the user illustrating the activity described in the activity label 62; and 3) a space 66 for the user to write his or her own observations and ideas on how to discuss the activity or environment pictured on the page with the child (subject).

In FIG. 13, text 68 under the designated space 62 for an activity label instructs the user to write a brief description of the activity portrayed in the photo that will be placed by the user. Further, text 72 on the page instructs the user how to insert the subject's photo into the designated space 64. In addition, text 92 on the page instructs the user to write in his own tips and notes in the space 66 which is provided to help the user discuss with his or her child the activity that will be pictured on the page.

FIGS. 13A, 13B, and 13C illustrate a mechanism for holding and retaining photos on a “template page” 52 of FIG. 13. This mechanism is the same mechanism, i.e., slits, used to hold and retain photos on to the “author's pages.”

FIG. 13A shows pair of slits, 80 and 81 that is cut into each corner of the square space 64. Square space 64 is referenced in FIG. 13 and designated to receive the photo 86 referenced in FIG. 13A. Each pair of slits is cut at an angle to the two perpendicular lines 64(i) that form a corner of the square space. The pair of slits, 80 and 81; are the same as those cut into the “author's page” and referred to in the previous explanation of FIG. 12B. As directional arrow 40 indicate, the user places each corner of the photo into four slits 81 which are directly below slits 80. In contrast, on the author's page in FIG. 12B, the user places the four corners of the photo into four slits 80 that are directly above slits 81. The result is illustrated by FIG. 13B, which is a detailed view of FIG. 13A. In FIG. 13B; one of the corners 84 of the photo 86 has been retained by a relatively thin strip of paper 82. Thin strip of paper 82 is the result of cutting slits 80 and 81 parallel to each other. Note that in an alternative embodiment of the invention, the slits 80 and 81 may be cut in a straight line instead of a curved line.

There are several alternative mechanisms to hold the user's photos to the book's pages. Please refer to FIGS. 7, 7A, 7B, 7C, 8,8A, 9 and 9A for the descriptions of the alternative mechanisms to hold the user's photo to the book's cover pages. These same mechanisms apply to holding the user's photos to the book's author's pages and template pages.

In another alternative embodiment of the mechanism to hold the user's photo's to the book's pages, the book is distributed with transparent sheets which have an adhesive applied to one side. The user will place the transparent sheet with adhesive side down onto the page and over the photo to hold the photo to the page. The transparent sheet will be slightly larger than the photo so that the adhesive on the edges of the transparent sheet will affix directly to the page, thus holding the photo onto the page.

FIG. 13C shows the subject's photo 86 after the user has placed the photo's four corners 84 into four slits 81 and out of four slits 80.

FIG. 13D shows a template page that has been completed by the user. The user has written in an activity title 94, e.g., “My School;” inserted the subject's photo 86, e.g., of the child's school; and written in the user's own tips 96 to help the user discuss with his or her child the activity or environment pictured on the page.

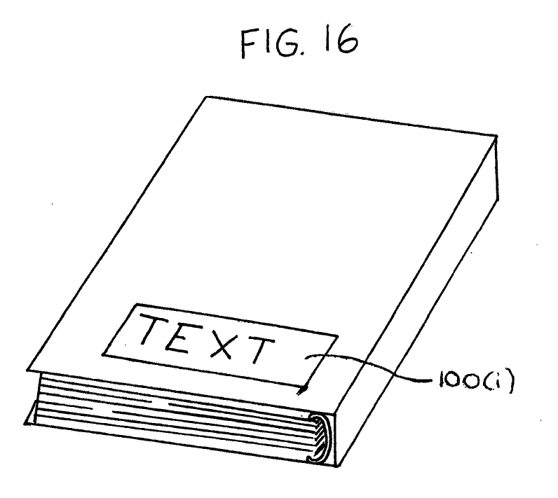

FIG. 14 illustrates an “author's page” 50 and a “template page” 52 that both have been personalized by the user. The user has added personal information to both of the pages in the following ways: On the author's page 50, the user has inserted the subject's photo 36 over the photo printed on the page. And, on the template page 52, the user has written in his own activity label 94, e.g., “My School,” inserted the subject's photo 86, and written in his own tips 96 to help him discuss the activity or environment pictured on the page with his child.

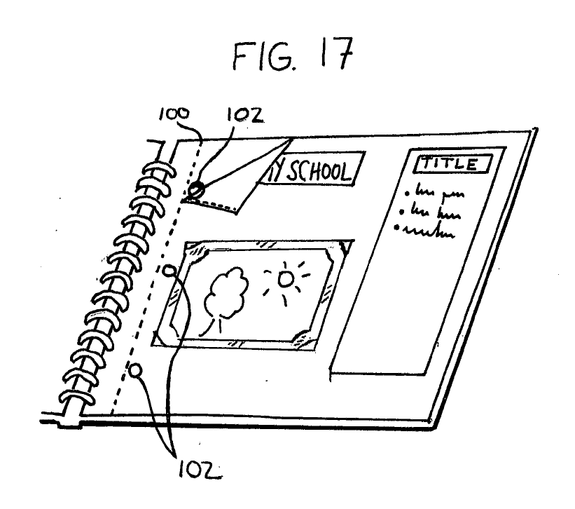

FIG. 15 is a daily diary, e.g., “My School Day Diary”99, intended to be a conversation starter to discuss school, or to be a periodic record of school-related activities. The diary page may be integral with the personalized activity book, or be separate from the book and the book can include enough pages so that each day may have a separate and dated diary page. Various activities 99(i) are left blank in the daily diary and can be filled in with reference to the activities illustrated and identified in the book. Information inserted into the diary can include, for example, the names of friends, topics of books read about, crafts made, as well as songs sung and food consumed. Finally, there is space 99(ii) in the diary for other things that the child would like to tell the parent. The school-day diary of FIG. 15 may be provided as pages in a separate envelope or book, so that a record of each school day may be made. Alternatively, the school-day diary may be provided as a single page that can be used as a conversation-starter to promote discussion about school experiences between child and parent or caregiver.

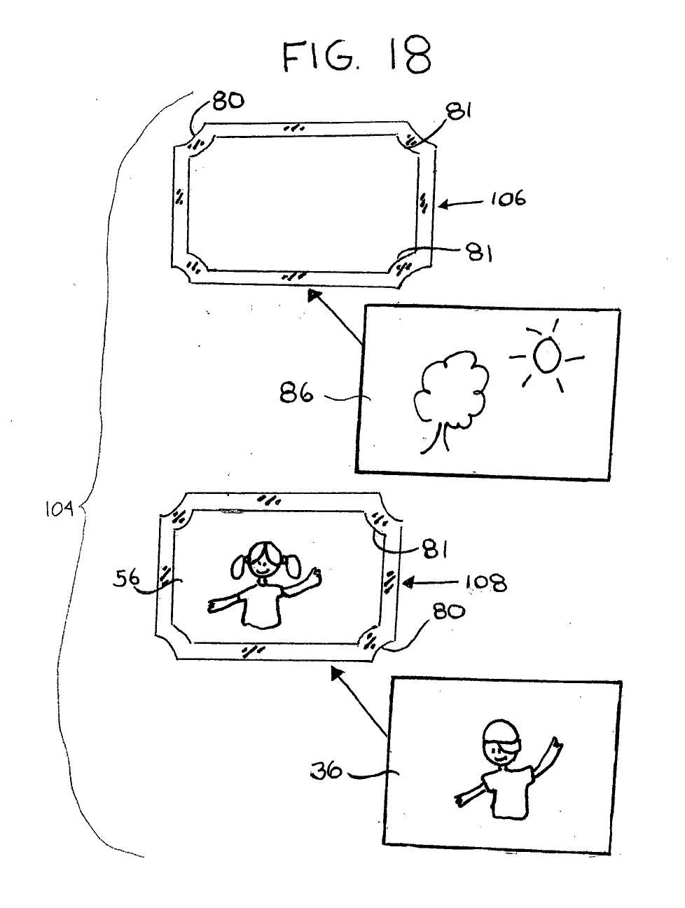

FIG. 16 is the back cover of the book and contains text 100(i) such as the author's contact information, website and additional information the author wants public.

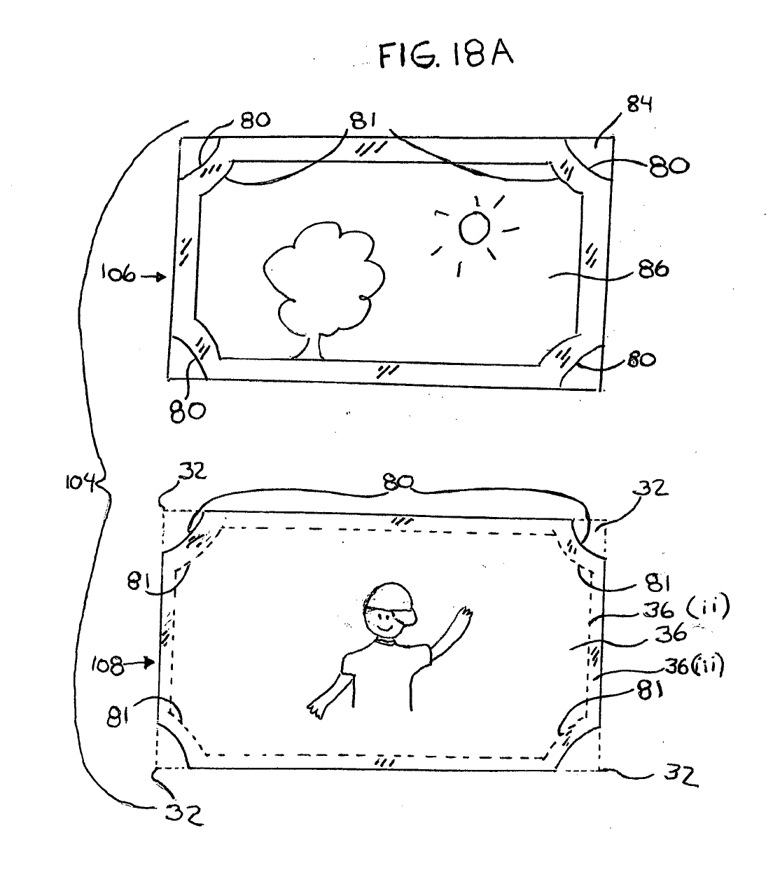

FIG. 17 is an alternative embodiment of the book in which each “template page” is perforated 100 or dotted 100 along the side of the page closest to the binding so that each page may be ripped out or cut out by the user and placed in any order the user wishes, to create a separate personalized activity book that reflects the order of the child's daily activities.

FIG. 17 further illustrates this same alternative embodiment of the book in which each template page contains notebook holes 102 on the side of the page closest to the book's binding. The purpose of these holes is for the user to have the option to easily bind the template pages after completing them and removing them from the book. This allows the user to create and bind a separate personalized activity book distinct from the original book. In this case, the user can bind the book with ribbon, string, staples—or place the template pages in a ringed notebook.

In a further iteration assuming the FIG. 17 embodiment of the template pages, the book will be distributed with loose ribbon or string, e.g. inside a pocket or envelope placed inside the book, that users can use to bind their completed template pages by placing the ribbon or string through the holes in the template pages and tying the ends.

In yet a further alternative embodiment of this book arrangement, the author's pages are grouped together and appear in the book before the template pages. Therefore, the template pages are grouped together and appear in the book after the author's pages. The author's pages may or may not offer the user the option to attach the child's (subject's) photos to the author's pages. The template pages will offer the user the option to add the child's (subject's) photos, activity labels, and parent's tips to the template pages. This book arrangement results in the creation of two books: The author's pages form one book and the customized template pages form another book. The user will be able to remove the template pages from the book arrangement to create a separate and distinct book from that of the author's pages. Further, there may be a page inserted in the book arrangement between the last author's page and the first template page to serve as a “book cover” for the book that is formed by the personalized template pages. This “book cover” could be personalized by the user if he or she writes the subject's (child's) name and attaches the subject's (child's) photo onto this “book cover.” This “book cover” could be removed by the user along with the personalized template pages to form the book cover of a separate and distinct personalized book. Therefore, the front cover of the entire book arrangement may not include an area to receive the name and photo of the subject (child).

FIGS. 18 and 18A are detailed views of two interior pages, e.g. pages 4 and 5, that are sequential and printed on opposite sides of the same sheet of paper 104. A photo 86 is placed by the user on a template page 4 (reference number 106); and a photo 36 is placed by the user on an author's page 5 (reference number 108) over the photo 56 already preprinted on the page. Therefore, 86 represents a photo that has been placed by the user on the template page 106, and 36 represents a photo placed by the user on the author's page 108 respectively. Slits 80 and 81 are visible in FIG. 18. As FIG. 18A illustrates, a “template page” 106 is typically printed on the other side of the same sheet of paper 104 as an “author's page” 108. Photo 86 and photo 36 overlap and are aligned on single sheet of paper 104. This creates a pleasing aesthetic when the user flips over sheet of paper 104. As a result of the placement of the four corners 84 of photo 86 by the user on template page 106 using four slits 81, the four corners 84 of photo 86 are visible on the page. The four slits 81 and four slits 80 also are visible on the page. In contrast, the four corners 32 of the photo 36 placed by the user on author's page 108 are invisible as a result of the placement of the four corners 32 of photo 36 into four slits 80. The four corners 32 of photo 36 are invisible on author's page 108 because they appear on the other side of the single sheet of paper 104. That is, they appear behind four corners 84 of photo 86 on template page 106. While the four slits 80 are visible on author's page 108, the four slits 81 are not visible on the page because they are covered by photo 36 that has been placed over them.

In addition, the inside graphic border line 36(ii) of the frame 36(iii) of the author's page 108 is not visible after the user's photo 36 is placed on the author's page. The reason is because the subject's photo 36 is placed over and covers the inside graphic border line 36(ii) of frame 36(iii).

One result of having page 108 and page 106 printed on opposite sides of the same sheet of paper, is that the four slits 81 plus four slits 80 cut into single sheet of paper 104 appear on both sides 108 and 106 of sheet of paper 104. In the current embodiment of the invention, users are instructed to use one set of four slits 81 to hold a photo placed on side 106 (template page) and another set of four slits 80 to hold a photo placed on side 108 (author's page). Refer to explanations of FIGS. 13, 13A, 13B, 13C and 13D for a description of how a photo is placed by the user on a template page and is held and retained by slits 81. Refer to explanations of FIGS. 12A, 12B, 12C, 12D, 12E and 12F for an explanation of how a photo is placed on an author's page and is held and retained by slits 80.

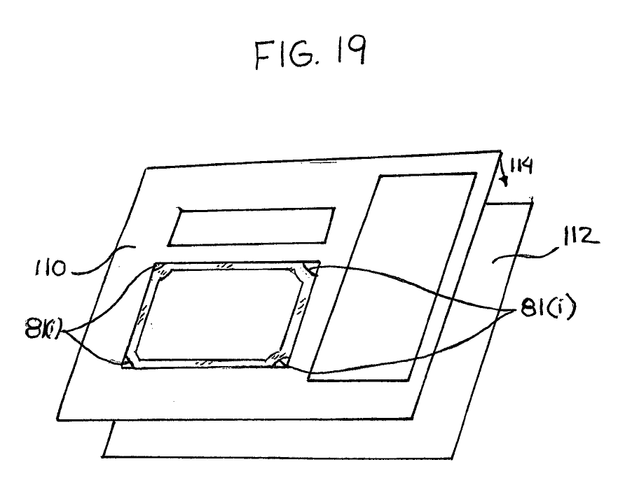

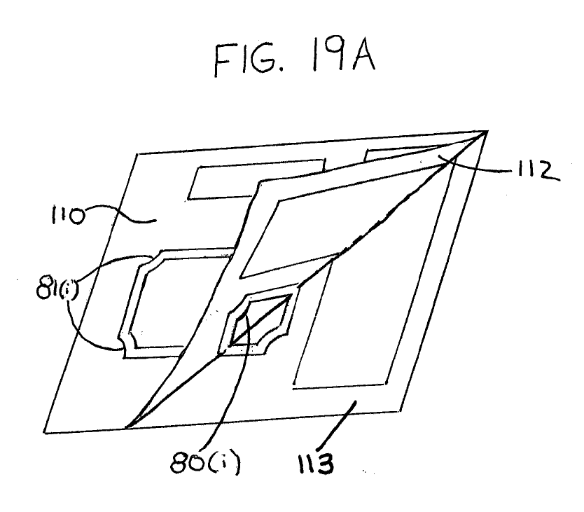

FIG. 19 is another iteration of the current invention: two individual sheets of paper, 110 and 112, are adhered back to back as directional arrow 114 indicates, to form two sides of a single book's page, as illustrated by FIG. 19A. In FIG. 19A, reference number 113 is the next page.

In FIGS. 19 and 19A, 110 and 112 are adhered back-to-back after four slits 81(i) are cut into 110, and four slits 80(i) are cut into 112. The result is that the slits do not go through from sheet 110 to sheet 112, or from sheet 112 to sheet 110. Instead each sheet of paper, 110 and 112, have only four slits each and form each side of a single book's page. Another iteration is to use thick cardboard pages, like those which are referred to as the pages of a “board book” by those schooled in the art of publishing children's books. In this case the slits made on either side of the single cardboard page will not go through to the other side of the cardboard page because the cardboard page is thicker than a single sheet of paper.

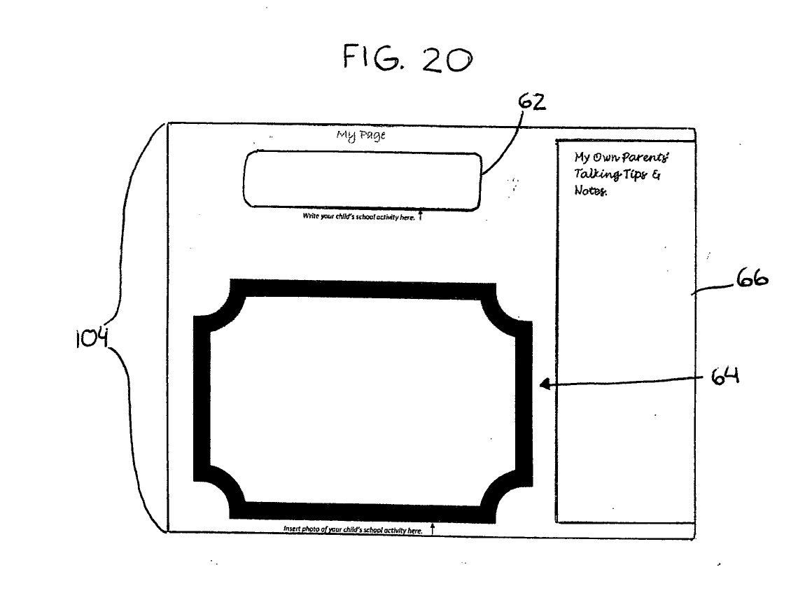

FIGS. 20-27 are eight examples of eight pages, pages 4-11, of the book arrangement. Each of these eight pages illustrates one example of a page configuration.

FIG. 20 is an example of a page 4 template page of the book arrangement. This page is the front side of single sheet of paper 104. The user has not personalized the page with a photo or text. The user has not done the following: attached a photo of the subject (child) in designated space 64, written an activity label in the designated space 62, nor written any text for parent tips in designated space 66. This is a first example of a page configuration.

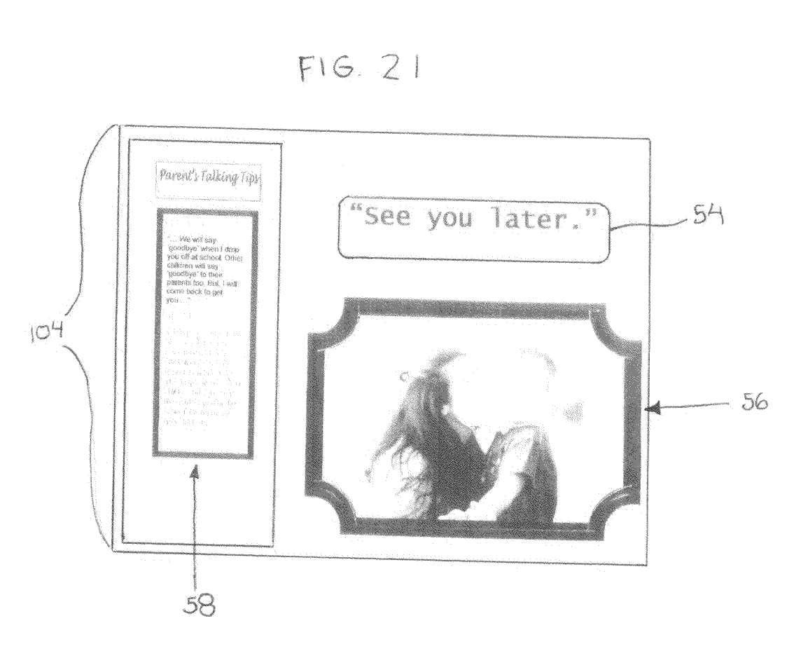

FIG. 21 is an example of a page 5 author's page of the book arrangement. This page is the back (opposite) side of the same single sheet of paper 104 in FIG. 20. No photo has been added by the user. Therefore, preprinted photo 56 is visible and has not been covered by a photo added by the user. The preprinted Parent's Talking Tips 58 and preprinted activity label 54 cannot be customized on author's pages. This is a second example of a page configuration.

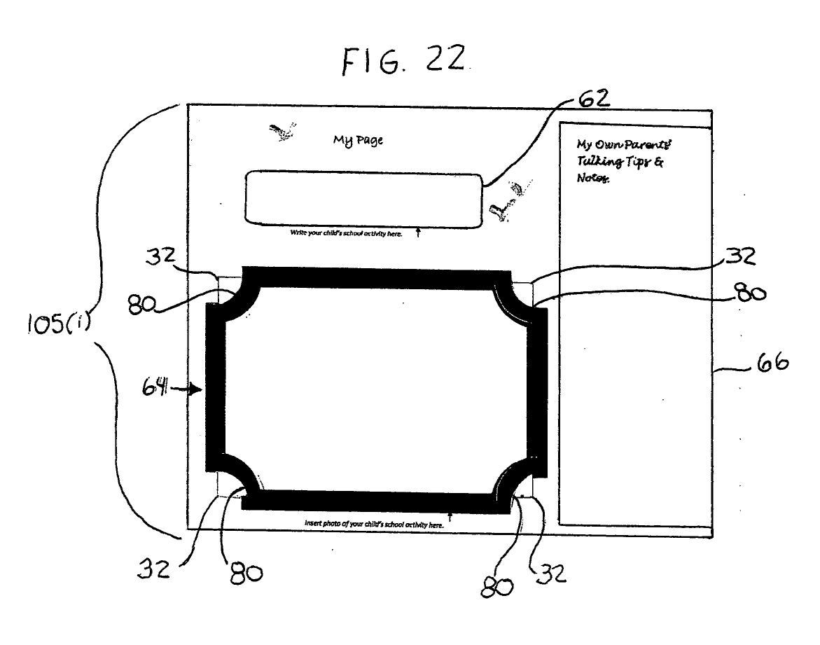

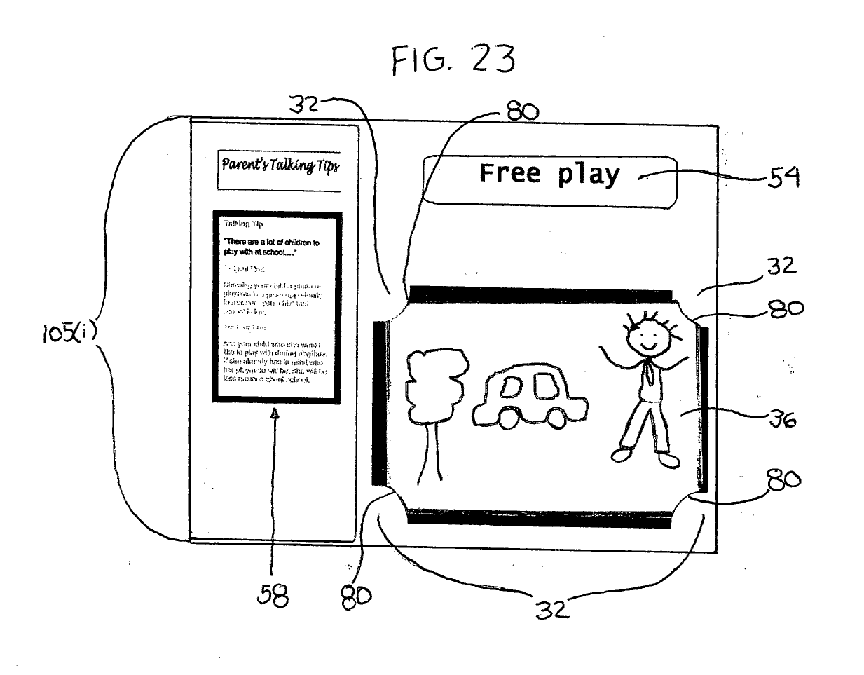

FIG. 22 is an example of a page 6 template page of the book arrangement. This page is the front side of single sheet of paper 105(i). The user has not personalized the page with a photo or text. The user has not done the following: attached a photo of the subject (child) in designated space 64, written an activity label in the designated space 62, nor written text for parent tips in designated space 66. Note that four corners 32 of the user's photo in FIG. 23 are visible in FIG. 22. This is because FIGS. 22 and 23 are printed on opposite sides of same sheet of paper 105(i). The user inserted the four corners 32 of photo in FIG. 23 into four slits 80. Four slits 80 are cut through to both sides of single sheet of paper 105(i), as illustrated in FIGS. 22 and 23. This is a third example of a page configuration.

FIG. 23 is an example of a page 7 author's page of the book arrangement. This page is the back (opposite) side of single sheet of paper 105(i) in FIG. 22. The user has personalized the author's page of FIG. 23 with a photo 36 of the subject (child). Parent's Talking Tips 58 and activity label 54 are preprinted on the page. Note that in FIG. 23, the four corners 32 of photo 36 are hidden under slits 80. However, in FIG. 22; the four corners 32 of photo 36 are visible. This is the fourth example of a page configuration.

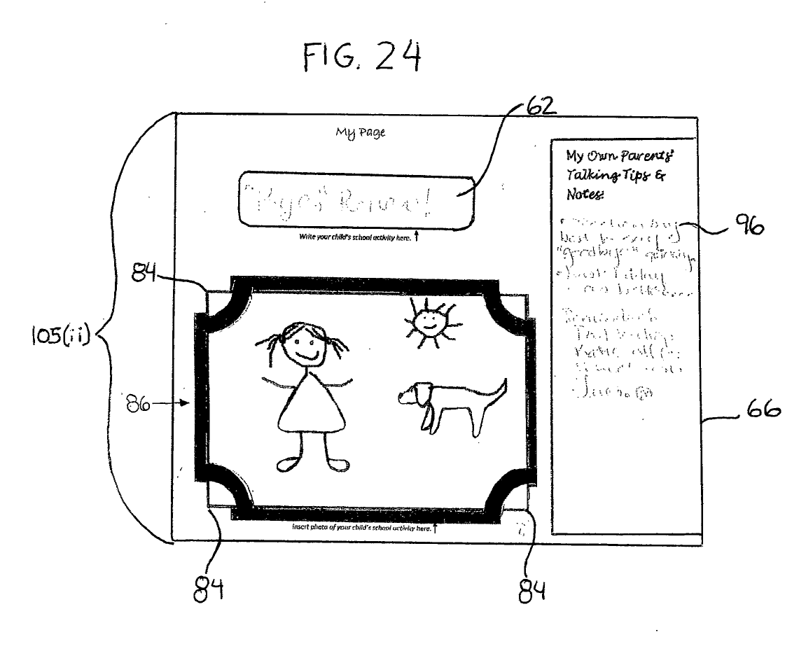

FIG. 24 is an example of a page 8 template page of the book arrangement. This page is the front side of single sheet of paper 105(ii). The user has personalized the page with a photo and text. The user has done the following: attached a photo 86 of the subject (child), written an activity description in the designated space 62, and written text 96 for parent tips in designated space 66. Note that the four corners 84 of the photo 86 are visible. This is a fifth example of a page configuration.

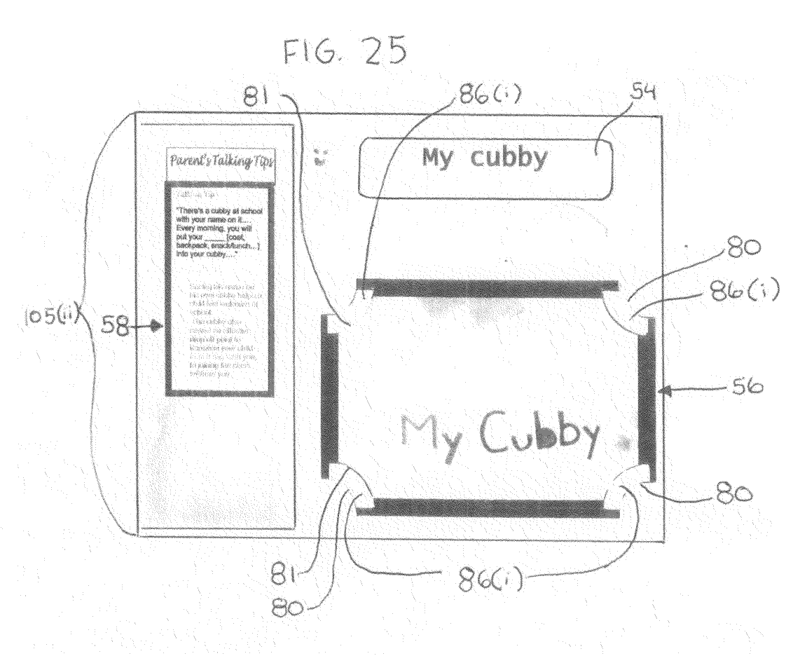

FIG. 25 is an example of a page 9 author's page of the book arrangement. This page is the back (opposite) side of single sheet of paper 105(ii) in FIG. 24. The user has not personalized the author's page of FIG. 25 with a photo of the subject (child). Photo 56 is pre-printed on the page, as are Parent's Talking Tips 58 and activity label 54. Note that the author's page of FIG. 25 displays a portion of the back 86(i) of the user's photo 86 in FIG. 24. This is because FIGS. 24 and 25 share the same sheet of paper 105(ii), and a portion of the back 86(i) of user's photo 86 in FIG. 24 is visible in between slits 80 and 81 of FIG. 25. This is a sixth example of a page configuration.

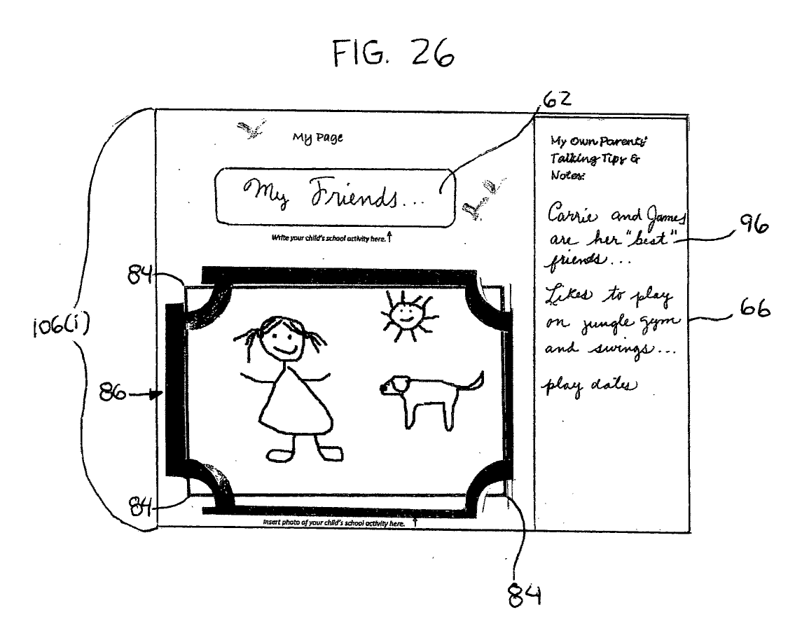

FIG. 26 is an example of a page 10 template page of the book arrangement. This page is printed on single sheet of paper 106(i). The user has fully personalized the page: The user has inserted a photo 86 of the child (subject), written an activity label in the designated space 62, and written text 96 for parent tips in designated space 66. Note that the corners 84 of the photo 86 are visible. This is the seventh example of a page configuration.

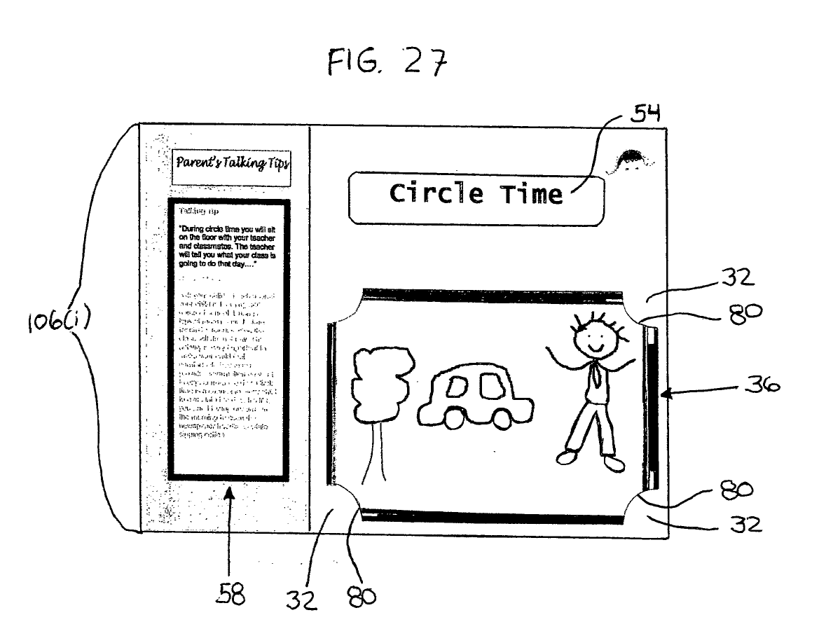

FIG. 27 is an example of an author's page 11 of the book arrangement. This page is the back (opposite) side of single sheet of paper 106(i). The user has personalized the author's page with a photo 36 of the subject (child). Parent's Talking Tips 58 and activity label 54 are preprinted on the page. Note that the four corners 32 of photo 36 are hidden under four slits 80 and therefore are not visible. Further, the four corners 32 of photo 36 are hidden behind the four corners 84 of photo 86 in FIG. 26. This is the eighth example of a page configuration.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A book arrangement for illustrating and describing the activities of at least one subject of the book arrangement who is being counseled by a user of the book arrangement, comprising:
a set of author's pages, the author's pages being preprinted with text and images in which the author of the book provides generic text and generic images, and
a set of template pages providing areas for users of the book to insert personalized content in the form of text directed to and photographs of the subject and/or activities related to the subject.

2. The book arrangement of claim 1 wherein the author's pages and the template pages are interleaved in a single volume.

3. The book arrangement of claim 1 wherein the author's pages contain: an activity label describing an activity, a photograph of the activity described by the activity label, and text tips providing instructions to the user on how to discuss the activity described on the page with the subject and wherein the template pages contain: a designated space for the users to write an activity label describing an activity, a designated space for the users to place a personalized photograph of the activity described by the activity label, and a designated space for the users to write tips and ideas to help the users discuss with the subject the activity described and pictured on the template pages.

4. The book arrangement of claim 2 wherein every author's page and template page contain at least four slits that are cut into each corner of a square space designated for receiving a subject's photo wherein each slit receives one corner of the subject's photo placed on the page to retain the entire subject's photo.

5. The book of claim 3 wherein each of the slits on the author's pages and template pages are cut at an angle to the two perpendicular lines that form each corner of the square space designated to hold and retain a photo of the subject placed by the user.

6. The book of claim 1 wherein there is a cover page with a designated space for the user to place a photo of the subject of the book, the cover page having slits for receiving the corners of the photo to retain the photo on the cover page.

7. The book of claim 1, further includes on each author's page text talking points and other information for users related to the activities illustrated in the photographs and described by the activity labels.

8. The book of claim 1, further includes on each template page a space for the user to write in his/her talking points and information related to the activities illustrated in the photographs and described by the activity labels.

9. The book of claim 1, further includes an informational statement page explaining the value of the information and activities in the book.

10. The book of claim 1, further includes an instruction page between the cover and activity pages explaining how to perform the activities in the book.

11. The book of claim 1, wherein the book is a children's book, the subject is a child and the user is a child's parent or caregiver.

12. The book arrangement of claim 1 wherein the activities comprise attending school, child care, preschool, pre-kindergarten, or kindergarten.

13. The book arrangement of claim 11, wherein the book has a last page which is a sample of a school-day diary suggesting topics the parent or caregiver can discuss with the child at the end of each school day.

14. The book arrangement of claim 1 wherein the book is spiral bound.

15. The book arrangement of claim 1 wherein author's pages and template pages are in separate books or sections of a single book.

16. The book arrangement of claim 1 wherein the author's page and template page are on opposite faces of one sheet and wherein there are aligned areas provided for receiving photographs, the aligned areas each having corners with slits through the corners for receiving corners of photographs to retain photographs on the opposite faces.

17. The book arrangement of claim 1 wherein there are areas for photographs provided by the user.

18. The book arrangement of claim 1 wherein the pages have areas each having corners with slits through the corners for receiving the corners of photographs provided by the user.

19. a method for acclimating subjects to unfamiliar activities comprising:
providing a book arrangement with author's pages and template pages, the author's pages being preprinted with text and images in which the author of the book provides generic text and generic images, and the book further providing template pages with areas designated thereon for inserting personalized content in the form of text directed to and photographs of the subject and/or activities related to the subject;
the user studying the author's pages and inserting photographs of the subject and text relating to the photographs on the template pages in accordance with instruction provided by the author, and
the user discussing the book with the subject using the text and photographs on the template pages and author's pages to familiarize the subject with the activities.

20. The method of claim 19 wherein the user is a parent or caregiver, the subject is a child and the activity is attending school, preschool, child care, pre-kindergarten, or kindergarten.

21. The method of claim 19 wherein the book arrangement is configured as a single book with the author's pages and template pages interleaved.

22. The method of claim 19 wherein the book arrangement comprises two books: one having the author's pages and one having the template pages.
